(19) United States
(12) Patent Application Publication
(10) Pub. No.: US 2008/0294899 A1
(43) Pub. Date: Nov. 27, 2008

(54) SECURE MANAGEMENT OF DOCUMENT IN A CLIENT-SERVER ENVIRONMENT

(75) Inventors: Marco R. Gazzetta, San Francisco, CA (US); Luke K. La, Oakland, CA (US); Mahesh P. Karnawat, Pune (IN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BoardVantage, Inc., Menlo Park, CA (US)

(21) Appl. No.: 11/623,014

(22) Filed: Jan. 12, 2007

Related U.S. Application Data
(60) Provisional application No. 60/759,773, filed on Jan. 17, 2006.

(51) Int. Cl. H04L 9/14

(52) U.S. Cl. 713/170; 713/171

(57) ABSTRACT

A computer-implemented method for securely handling a document in a client-server environment includes receiving at a server a request from a user to initiate a session to access a plurality of documents stored in a server. The documents include a first type that is allowed to be accessed only while the user is online and a second type that is allowed to be accessed while the user is both online and offline. The server transfers at least one offline vault key and at least one online vault key to a client enable the client to load the documents and enable the user to access the documents, the documents including at least one document of first type and at least one document of second type.

### CROSS REFERENCE TO RELATED APPLICATION

The present application claims priority to Application No. 60/759,773, filed on Jan. 17, 2009, which is incorporated by reference.

### BACKGROUND OF THE INVENTION

The present invention relates to a method and system for securely handling documents in a client-server environment, more specifically, a method and system for securely providing offline access to sensitive documents stored at a server to generate a confidential board book for use in a board-of-directors meeting.

Directors of public companies need information to be able to fulfill their fiduciary role. Since they are not typically internal employees, this information needs to be generated for and disseminated to them. Historically, the office of Corporate Secretary was instituted to handle (amongst other things) the flow of documents to the Directors. When a board meeting is approaching, documents were sent as binders (“board books”) to each Director. The Directors would then prepare for the board meeting and convene at a specified location and time.

This paper-based process has several drawbacks: (1) the time required to ship a document generates artificial latency, (2) the shipping process is not secured, (3) shipments can be lost, causing both the loss of confidential information and the need to provide a different means of disseminating the same information to the Director, (4) the physical board books tend to be heavy, causing burden especially for traveling Directors, and (5) navigation in a physical board book is hard because of the large number of pages involved.

In addition, with the recent corporate scandals, many corporations are examining their board practices and exploring new ways of conducting their businesses. Corporate governance is undergoing dramatic changes, with more regulations and increasing shareholder demands for better accountability, as noted by Karen Cottle in an article entitled, “Electronic Board Materials,” Directors Monthly, September 2004. Corporate directors of today are highly interested in improving information control and security. To respond, many boards are reevaluating how confidential corporate information is managed and distributed.

Board information management systems, Web-based solutions, are giving some boards rapid access to timely, secure information. Content in board packets that was previously printed and couriered hours before meetings can now be made available via secure extranets as soon as materials are prepared.

Ultimately, any board process has to address critical security issues. This is can be a daunting task when working with directors. Some members have access to only certain committee reports, while others might be permitted to view all reports. It's also possible that a member of the executive team can view select documents, e.g., audit committee findings. To further complicate matters, security might even be needed within documents, because some directors might be allowed to view everything except a given page or two of a report.

Secure, electronic access to board materials (or board books) can help directors better respond to increasing pressures from shareholders and regulatory agencies. From board members' perspectives, the online systems support how they work by giving them anywhere, anytime access to essential information. From the view of shareholders, a more informed, better-connected board should help achieve the main goal of improved corporate governance.

Despite the above benefits, one of the issues with the use of electronic board books is the requirement of being online and connected to the server to access them. This may be problematic if a director wants to review the documents in an airplane or coffee shop where the Internet connection is not available. Another issue is that a complete board book may require a significant time to download to the director's computer. It would be desirable to resolve these and other concerns to make the use of electronic board books easier and more user friendly.

### BRIEF SUMMARY OF THE INVENTION

The present invention relates to secure handling of confidential documents in a client-server environment. Embodiments of the present invention relate to securely accessing the electronic board materials or books while offline.

In one embodiment, the present invention is implemented using a Secure Vault, which is a control that is embedded in a browser page at a client. When activated by an application on a server, the Secure Vault communicates with the server to facilitate the exchange of information between the client and server, download and upload documents, encrypt downloaded files for offline use. When a user clicks a document link after login onto the server, the corresponding file is downloaded to the user's computer (or client computer) by the Secure Vault. The file is stored as an encrypted file in a location whose name is also encrypted. The file is then decrypted into a temporary location and the corresponding application is started and enables the user to access the file. Once the user has finished accessing the file, the Secure Vault encrypts the local temporary file into its permanent location in the client computer and wipes the temporary file. On subsequent attempts to open the same file, the Secure Vault decrypts the local copy and opens it up in an application window, thereby improving performance and providing offline access.

In one embodiment, the server displays a plurality of documents to the user. A first set of the documents are files that the user has permission to access while the user is offline, and a second set of the documents are files that the user may view only when the user is online. Different users may have different first and second sets of documents that they may be accessed both while online and offline, or while only online.

In one embodiment, a computer-implemented method for securely handling a document in a client-server environment includes receiving at a server a request from a user to initiate a session to access a plurality of documents stored in a server. The documents include a first type that is allowed to be accessed only while the user is online and a second type that is allowed to be accessed while the user is both online and offline. The server transfers at least one offline vault key and at least one online vault key to a client enable the client to load the documents and enable the user to access the documents, the documents including at least one document of first type and at least one document of second type.

In another embodiment, a computer-implemented method for securely handling a document in a client-server environment includes receiving at a server a request from a user to initiate a session to access a plurality of documents stored in a server, the documents include a first type that is allowed to be accessed only while the user is online and a second type that is allowed to be accessed while the user is both online and offline; and transferring at least one offline vault key and at least one online vault key to a client to enable the client to load the documents and allow the user to access the documents, the documents including at least one document of first type and at least one document of second type. The document of first type is encrypted with an online key, and the document of second type is encrypted with an offline key, and the online key is saved in a first ancillary file, and the offline key is saved in a second ancillary file. The first ancillary file is encrypted using the online vault key, and the second ancillary file is encrypted using the offline vault key.

The method further comprises authenticating the request from the user; and generating a download list and an upload once the user request has been authenticated to synchronize the client and server, the download list including files that need to be downloaded to the client and the upload list including files that need to be uploaded to the server. The user is not allowed to access the documents until the files in the download list have been downloaded and the files in the upload lists have been uploaded.

The user reviews and makes an annotation on a given document, and the method further includes uploading an annotation file that includes the annotation made on the given file from the client to the server; and storing the uploaded annotation file as a new file at the server, the new file being linked to the given file. Only the user is granted access to the new file unless the user grants access to another user. The new file is downloaded to a client associated with another user when the another user successfully logs onto the server if the user had indicated that the user wishes to grant the another user access to the new file.

### BRIEF DESCRIPTION OF THE DRAWINGS

FIG. 1 is a simplified block diagram of an exemplary computer system which may incorporate embodiments of the present invention.

FIG. 2 illustrates logical components in a client-server system according to one embodiment of the present invention.

FIG. 3 illustrates a user's view of Secure Vault according to one embodiment of the present invention.

FIG. 4 illustrates a key management system according to one embodiment of the present invention.

FIG. 5 illustrates a login process according to one embodiment of the present invention.

FIG. 6 illustrates an instance where a user has a plurality of Secure Vaults according to one embodiment of the present invention.

FIG. 7 illustrates an instance where a given document is modified by a plurality of users according to one embodiment of the present invention.

FIG. 8 illustrates an instance where a user is a director in multiple companies according to one embodiment of the present invention.

FIG. 9 illustrates a data synchronization process according to one embodiment of the present invention.

FIG. 10 illustrates a process for synchronizing annotations to a document according to one embodiment of the present invention.

### DETAILED DESCRIPTION OF THE INVENTION

Embodiments of the present invention relate to providing secure offline access to documents stored at a remote location or server. The present embodiments use an innovative technology, i.e., Secure Vault Technology, to provide secure offline access, easy annotations, and improved file handling of sensitive documents associated with the board books.

As explained in U.S. patent application Ser. No. 11/072,037, filed on Mar. 3, 2005, which is incorporated by reference, a method of securely accessing documents stored at a server from a client to generate and disseminate board books solves many of the problems and concerns associated with the paper-based process. In the client-sever system, board members are given login credentials to the system, and corporate secretaries (or the contributors directly) upload the document to a server, allowing for viewing, printing, and downloading of board book. As used herein, the term “book” refers to a document including a plurality of pages that may or may not be bound.

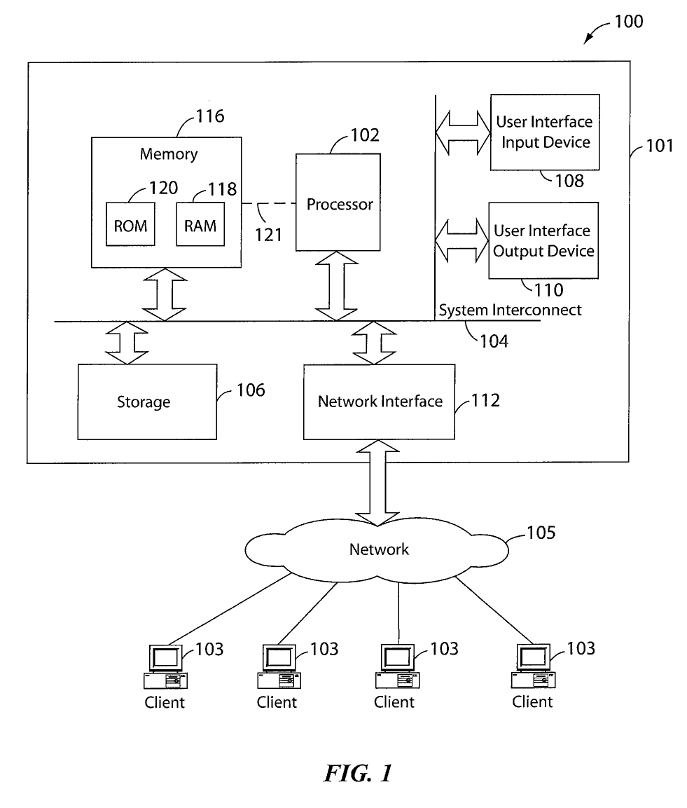

FIG. 1 is a simplified block diagram of an exemplary computer system 100 which may implement embodiments of the present invention. Computer system 100 includes a server 101 provided at a secure location and a plurality of clients 103 from where the server can be accessed via a network 105.

Server 101 includes at least one processor or central processing unit (CPU) 102, which communicates with a number of peripheral devices via a system interconnect 104. System interconnect 104 may be a bus subsystem or switch fabric, or the like. The system interconnect is also referred to as the main internal bus. These peripheral devices may include storage 106. Storage 106 may be enclosed within the same housing or provided externally and coupled to the system interconnect via a communication link, e.g., SCSI. Storage 106 may be a single storage device (e.g., a disk-based or tape-based device) or may comprise a plurality of storage devices (e.g., a disk array unit).

Storage system 106 includes a document repository. In the present implementation, the repository is a traditional hierarchical file structure with folders and documents contained therein. Access to both folders and documents is granted using security access mechanism that allows for fine-grained authorization resolution. The server system knows the following access levels in one implementation.
Deny access—a user has no access to the document (and will not know about its existence)
Undefined access—a user or group has no access to the document, unless some other setting allows for access (this is the default)
Read-only access—a user or group can access the document only for viewing
Read-save access—a user or group can access the document for online viewing, downloading and printing
Read-edit access—a user or group has read-save access and can modify the content of the document
Ownership access—a user or group has full privileges

Referring back to FIG. 1, the peripheral devices also include user interface input devices 108, user interface output devices 110, and a network interface 112. The input and output devices allow user interaction with server 101. The users may be humans, computers, other machines, applications executed by the computer systems, processes executing on the computer systems, and the like. Network interface 112 provides an interface to outside networks and is coupled to communication network 105, to which other computers or devices (e.g., clients 103) are coupled.

User interface input devices 108 may include a keyboard, pointing devices (e.g., a mouse, trackball, or touchpad), a graphics tablet, a scanner, a touchscreen incorporated into the display, audio input devices (e.g., voice recognition systems), microphones, and other types of input devices. In general, use of the term “input device” is intended to include all possible types of devices and ways to input information into server 101 or onto network 105.

User interface output devices 110 may include a display subsystem, a printer, a fax machine, or non-visual displays such as audio output devices. The display subsystem may be a cathode ray tube (CRT), a flat-panel device such as a liquid crystal display (LCD), or a projection device. The display subsystem may also provide non-visual display such as via audio output devices. In general, use of the term “output device” is intended to include all possible types of devices and ways to output information from computer system 100 to a user or to another machine or computer system.

Processor 102 is also coupled to a memory subsystem 116 via system interconnect 104. Memory subsystem 116 typically includes a number of memories including a main random access memory (RAM) 118 for storage of instructions and data during program execution and a read only memory (ROM) 120 in which fixed instructions are stored. In one implementation, a dedicated bus 121 couples the processor and the memory subsystem for faster communication between these components.

Memory subsystem 116 cooperates with storage 106 to store the basic programming and data constructs that provide the functionality of the various systems embodying the present invention. For example, databases and modules implementing the functionality of the present invention may be stored in storage subsystem 106. These software modules are generally executed by processor 102. In a distributed environment, the software modules and the data may be stored on a plurality of computer systems coupled to a communication network 105 and executed by processors of the plurality of computer systems.

Generally, storage 106 provides a large, persistent (non-volatile) storage area for program and data files, and may include a hard disk drive, a floppy disk drive along with associated removable media, a Compact Digital Read Only Memory (CD-ROM) drive, an optical drive, or removable media cartridges. One or more of the drives may be located at remote locations on other connected computers coupled to communication network 105.

System interconnect 104 provides a mechanism for letting the various components and subsystems of server 101 communicate with each other as intended. The various subsystems and components of server 101 need not be at the same physical location but may be distributed at various locations within a distributed network. Although system interconnect 104 is shown schematically as a single bus, alternate embodiments of the bus subsystem may utilize multiple buses. The system interconnect may also be a switch fabric.

Server 101 itself can be of varying types including a personal computer, a portable computer, a storage server, a workstation, a computer terminal, a network computer, a television, a mainframe, or any other data processing system. Due to the ever-changing nature of computers and networks, the description of the server depicted in FIG. 1 is intended only as a specific example for purposes of illustrating the preferred embodiment of the present invention. Many other configurations of server 101 are possible having more or less components than the server depicted in FIG. 1.

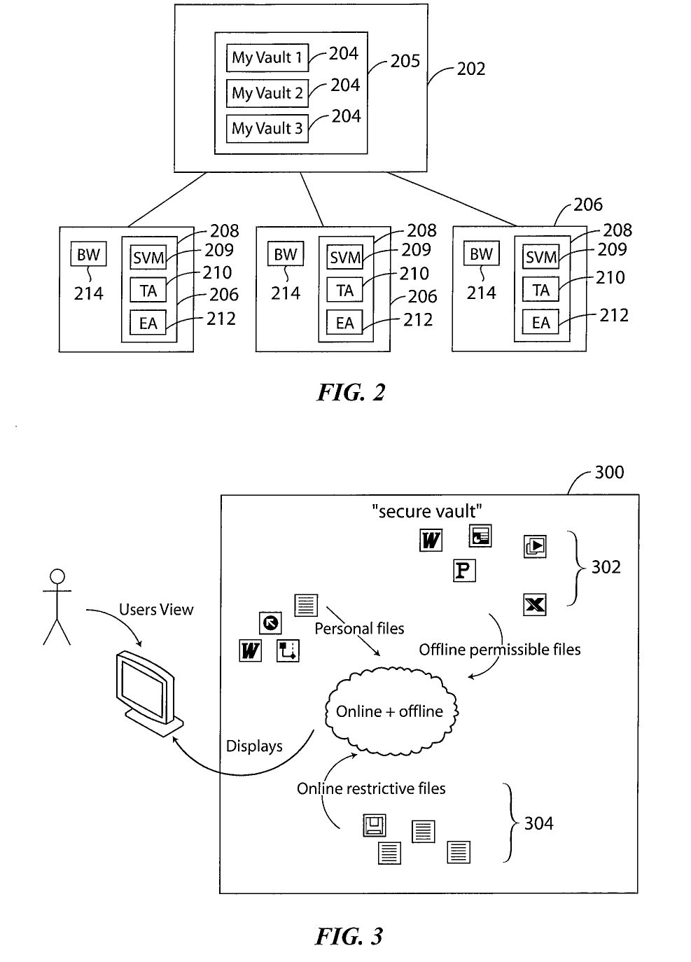

FIG. 2 illustrates logical components in a client-server system 200 according to one embodiment of the present invention. A server 202 includes a plurality of My Vaults 204 that together comprise a Global Vault 205. Each user is provided with his or her own folder or vault that includes all the documents the user is authorized to access. Each client 206 includes a Secure Vault 208 and a browser 214. The Secure Vault is a control that is embedded in a browser page of the browser 214 that allows the user to easily retrieve, manage, modify, distribute, and store sensitive documents securely on the local computer. If any modification is made within the Secure Vault, the modification gets placed into the original location in the corresponding My Vault. That is, the content of the Secure Vault and the corresponding My Vault are synchronized. The Secure Vault may be activated or deactivated according to the user preference. A Secure Vault manager 209 manages the components associated with the Secure Vault 208 and serves as an entry point for the browser. An internal “transfer agent” 210 is an object that encrypts and decrypts files received from the server. An “evolve agent” 212 operates within the Secure Vault to send commands to the server, as will be explained later.

FIG. 3 illustrates a user's view of Secure Vault 300 according to one embodiment of the present invention. A plurality of documents is displayed on the client computer. A first set 302 of the documents are files that the user has permission to access while the user is authenticated offline. A second set 304 of the documents are files that the user may view only when the user is online. Different users may have different first and second sets of documents that they may access while both online and offline, or while only online. A third set 306 of the documents are the user's personal files. From a user's perspective, the Secure Vault is a mirror image of a folder (or My Vault) on the server side. This means that a user can access the same series of files online (by accessing the My Vault folder), or via the Secure Vault.

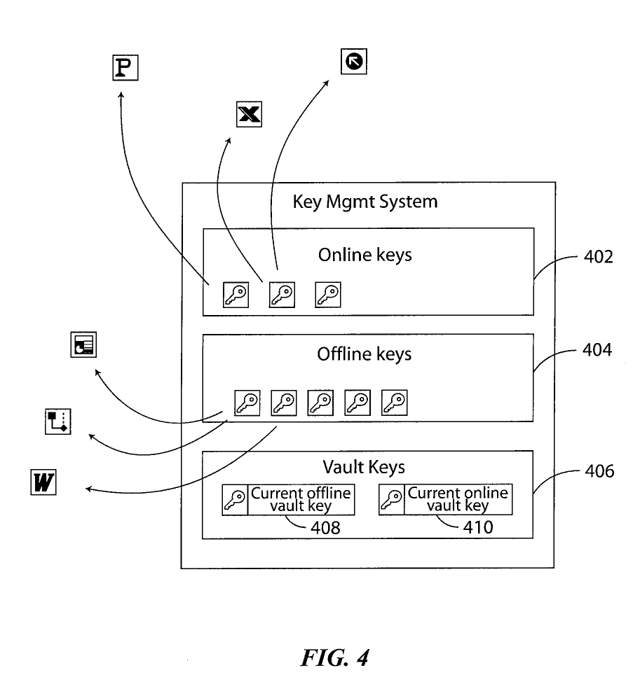

FIG. 4 illustrates a key management system according to one embodiment of the present invention. The key management system includes a set or list 402 of online keys, a set or list 404 of offline keys, and vault keys 406. The vault keys 406 comprise a current offline vault key 408 and a current online vault key 410. The server generates the online and offline keys. The online keys are the keys that decrypt the files that are supposed to be accessed by the user only when the user is online. The offline keys are the keys that decrypt the files that may be accessed by the user both online and offline. None of the keys are stored in clear text on the client computer. To add another layer of security, the online key list 402 is encrypted using the online vault key 410. The online keys in the list 402 cannot be accessed without the online vault key 410. The online vault key 410 is made available to the Secure Vault (or local computer) after the user has successfully login to the server. The offline key list 404 is encrypted using the offline vault key 408.

The keys are safely locked on the client computer until the server transmits the online and offline vault keys required to unlock the Secure Vault and open the files. During startup, the server sends the current and deprecated keys to the Secure Vault. The Secure Vault then goes through all the keys transmitted until one unlocks the corresponding vault. At that point, all “deprecated keys” are overwritten and discarded from the client's system memory.

The offline vault key is generated using the user's pass-phrase that was manually set while online and can be changed at the user's discretion. The online vault key is randomly modified by the server at determined interval. The online keys are not shared with the offline keys or vault keys. Each file in the Global Vault is associated with a key in the key manager. A key may be associated with one or more files. These files have pointers to indicate the keys that were used to encrypt the files. The online and offline keys are created and added at a random interval.

All files stored in the Vault at rest are encrypted. The encryption key is in turn encrypted in a configuration file. The encryption key to the configuration file is stored on the server, so that access to the encrypted documents requires a login to the server. The encrypted file is not readable without the encryption key. Accordingly, the quality of the encryption is not marred by a weak link, such as, a password, pass phrase, or the like.

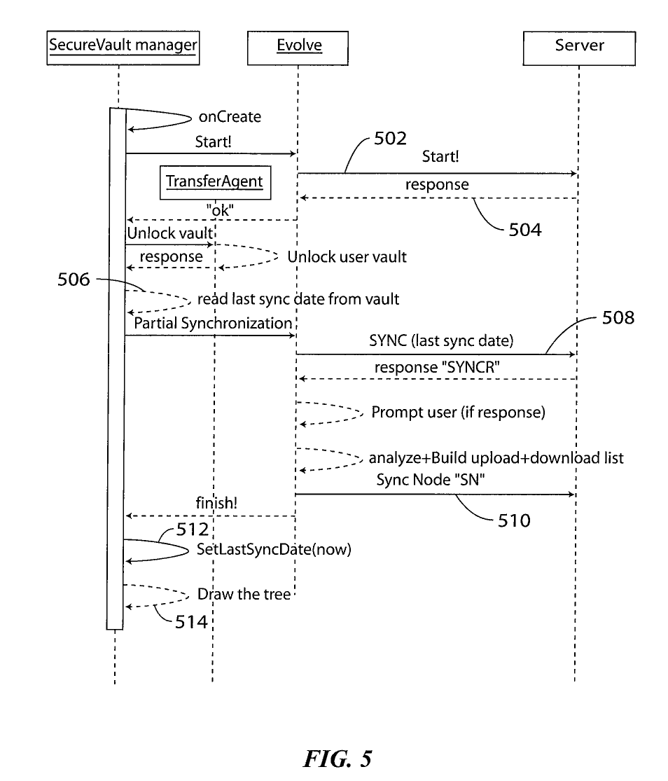

FIG. 5 illustrates a login process according to one embodiment of the present invention. The user authentication and document synchronization occurs as part of the login process. The Secure Vault manager issues a “start” command to the server (or BV application) via the evolve agent to initiate a session (step 502). The server sends the administrative information, e.g., file size, extensions, allowed attributes, etc., to the client (step 504). The keys are also transmitted to the client control during “start.” Once the Secure Vault is unlocked, the last synchronized date is read (step 506), and if the synchronization was performed within a given time, e.g., within the same day, without additional changes to the Secure Vault, no further synchronization is performed. Otherwise, the synchronization is invoked passing the last synchronization date to the server (step 508). The server determines if any changes were made on the server side to warrant any downloads. If any changes did occur (e.g., user modified files, user dragged and dropped files), the contents of the Secure Vault and My Vault are synchronized using the download and upload list (step 510). Once the synchronization has been completed, the last synchronization date is set (step 512) and the file structure is drawn (step 514).

Once the session has been initiated, a user may manually download any file that he or she is authorized for offline access by clicking a corresponding document link. The file is stored as an encrypted file in a location whose name is also encrypted. The file is then decrypted into a temporary location and the corresponding application is started to enable the user to access the file.

Once the user has finished accessing the file, the Secure Vault encrypts the local temporary file into its permanent location in the client computer and permanently wipes the temporary file to physically remove the data (rather than merely performing a logical removal). On subsequent attempts to open the same file online or offline, the Secure Vault decrypts the local copy and opens it up in an application window, thereby improving performance and providing offline access.

To avoid these temporary files from remaining on the computer due to software malfunction, the Secure Vault deletes all temporary files on shutdown and startup according to one implementation. This deletion occurs using the shredding function; i.e., the physical location on the drive is overwritten, leaving no trace of the original file content.

Since the documents are stored locally on the client computer, the network connection speed is irrelevant. This is particularly important with board books that can be several dozens of MB in size and take a long time, e.g., 30 minutes, to download even on a high speed Internet connection. In addition, the documents are available for offline use so the directors can review the documents even while on an airplane.

Files added to the Secure Vault, e.g., via drag & drop, are automatically pushed to the Global Vault (and thus to the My Vault folder) for future online use, obviating the need for conscious synchronization. One benefit of this is the ability to continue using the files even when a user uses multiple computers.

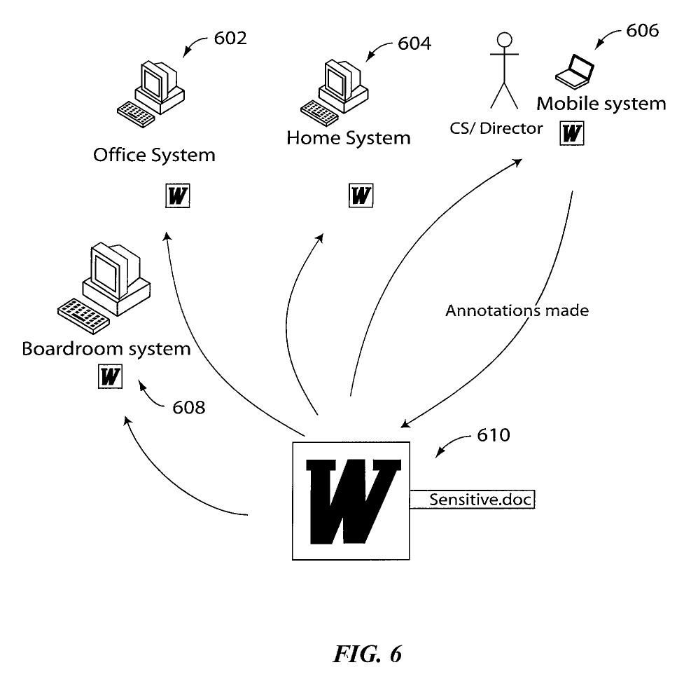

FIG. 6 illustrates an instance where a user has a plurality of Secure Vaults 602, 604, and 606 according to one embodiment of the present invention. The user has a different Secure Vault for each computer that he or she uses to access the server. A master copy 408 is stored at the Global Vault 610 at the server. If the user modifies a document using the Secure Vault 602 associated with office system and synchronizes the master copy with the modified document, the user may then use the Secure Vault 606 associated with the mobile system to work on the modified document at a later time, subject to restrictive constraints on Secure Vault 606, that may differ from those of Secure Vault 610, e.g. with respect to the expiration date, etc.

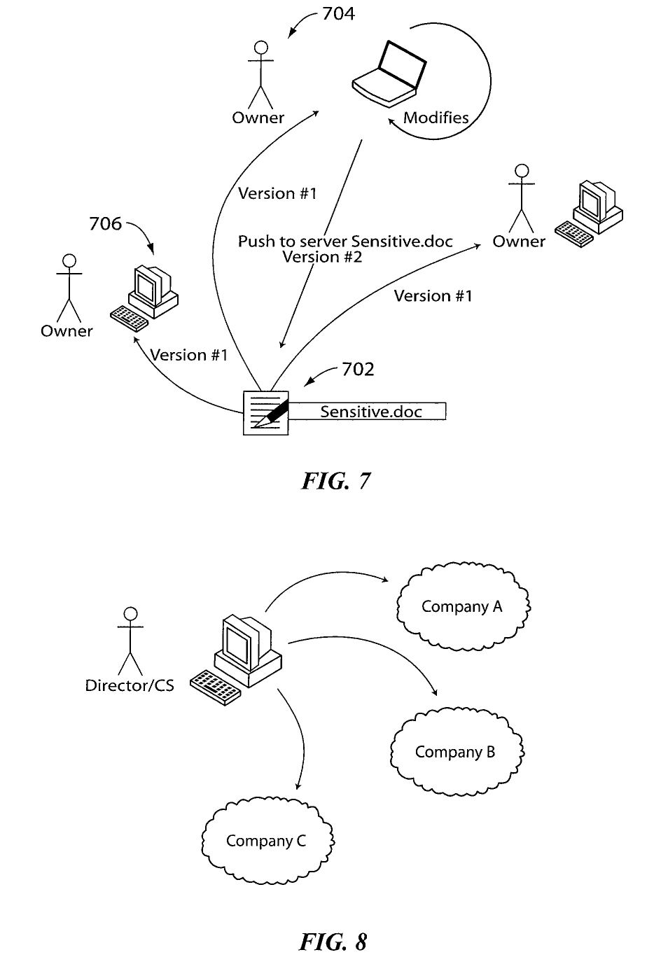

FIG. 7 illustrates an instance where a given document is modified by a plurality of users according to one embodiment of the present invention. A file 702 has multiple owners. A director can annotate, modify, remove or notify other directors of a document's existence or changes. A first owner or director 704 modifies the document and uploads the modified document (or synchronizes with the original document). The modified version is then downloaded to the Secure Vaults of other directors to ensure that these directors work with the latest version of the documents when they login. However, if a second director 706 modifies his or her version of the document on his or her Secure Vault prior to receiving the latest version of the document from the server and then logs into the server, the version of the second director is marked “stale” by the server. In addition, the latest version of the document is downloaded to the Secure Vault of the second director to be merged to the second director's version.

FIG. 8 illustrates an instance where a user is a director in multiple companies according to one embodiment of the present invention. The user is provided with a separate Secure Vault for each company to prevent sensitive data of one company from being amalgamated with that of another company. Accordingly, the Secure Vaults are configured, so that the user cannot drag and drop a file from one Secure Vault directly to another Secure Vault. If the user wishes do that, the user is required to manually and intentionally perform this operation, thereby preventing potential accidental amalgamation of data.

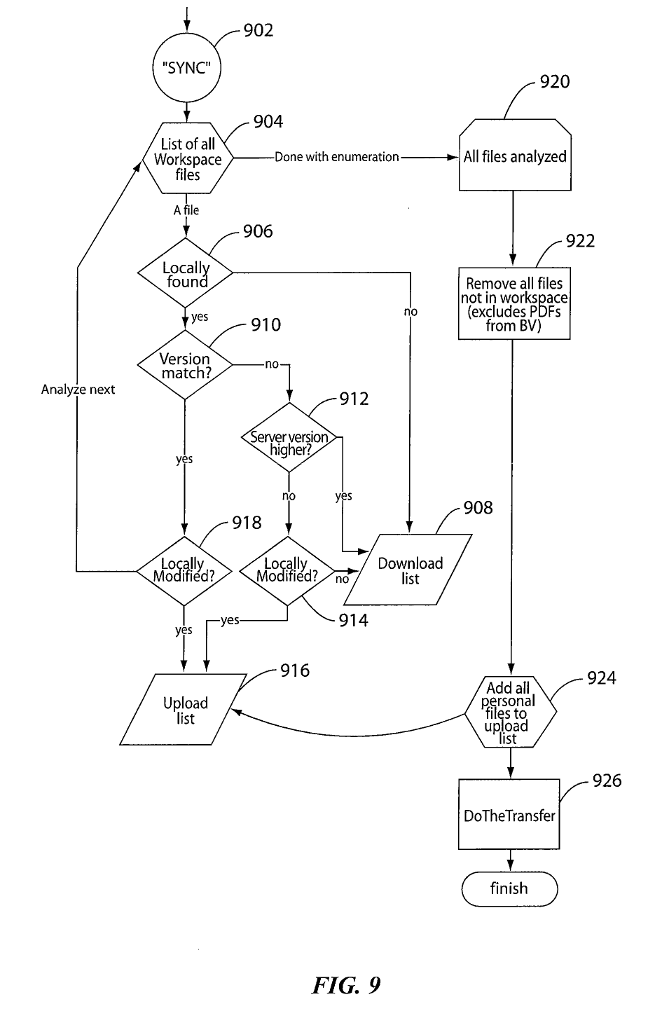

FIG. 9 illustrates a data synchronization process according to one embodiment of the present invention. As illustrated, online-only restrictive files are not synchronized. Personal files are automatically uploaded to the server when the process begins. All files analyzed get “marked” as visited to prevent the automatic deletion when the synchronization occurs. The files that are normally not marked, such as, expired, personal files and hyper-linked PDF files are exempt from deletion according to the present implementation. The files that need to be synchronization are added to the upload and download lists for upload/download. When the server is asked to synchronize, the individual file information includes (1) node ID, (2) version, (3) permission, (4) parent ID, (5) name, (6) byte-length, and (7) timestamp.

The files on the Secure Vault are synchronized to those on the My Vault by carefully keeping files and file versions current. For example, if a file is added to the My Vault, the file is synchronized to the Secure Vault whenever the user logs into the server. If a file is added to the Secure Vault, it is synchronized to the My Vault (i.e., Global Vault) as soon as the user logs in. If the file is added to the Secure Vault while the user is logged in, the synchronization occurs instantaneously. From there on, the file is available online and offline. If a file is removed from the My Vault folder, the file is removed from the Secure Vault when the user logs into the server as part of the login process. This occurs prior to allowing the user to open the file to prevent the “removed” file from being viewed or modified.

According to one embodiment, a file can be removed from the Secure Vault only when the user is online. In such a case, removing a file from the My Vault (or Global Vault) also removes it from the Secure Vault. When a file is updated on the server, a corresponding file in the Secure Vault is synchronized with the updated file the next time user logs into the server. If a file has been modified both in the Secure Vault and on the server, the Secure Vault version is uploaded as a new file into the My Vault folder and two versions of the file are kept in the My Vault and Secure Vault.

Referring back to FIG. 9, the synchronization process involves the server building a list of all files in the My Vault to determine whether or not synchronization is needed (step 902). One of the file is selected from the list (step 904). The file is examined to determine whether or not it is found in the Secure Vault. If not, the file is added to the download list (step 908). If the file is in the Secure Vault, the version of the file in the Secure Vault and that in the My Vault are compared (step 910). If the versions are not the same, it is determined whether or not the version in the My Vault is higher (step 912). If so, the file is added to the download list. If not, it is determined whether or not the file has been modified locally (step 914). If the file is determined to be have been modified locally, the file is added to the upload list (step 916). The file is added to the upload list if it is determined to have been modified as long as the server does not have a higher version of the file than the Secure Vault, i.e., even if the versions of the file match (step 918).

Once all files in the list have been analyzed (step 920), the files in the Secure Vault that that are not found in the My Vault are removed, so that the files that have been deleted in the server would not be available locally (step 922). Any file that the user indicates as needing to be uploaded is added to the upload list (step 924). For example, the user may wish to upload an MP3 file that he or she may want to listen to using another computer (see FIG. 6). The files in the download list are sent to the local computer, and the files in the upload list are sent to the server (step 926).

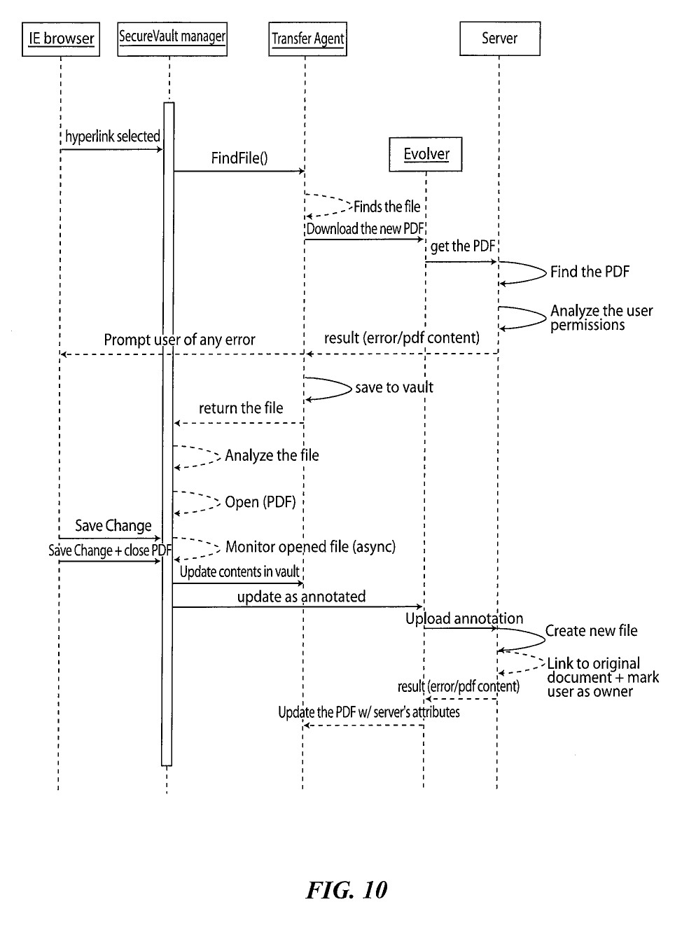

FIG. 10 illustrates a process for synchronizing annotations to a document according to one embodiment of the present invention. The annotations correspond to the notes written on the paper board book by the director. Accordingly the actual document is in a PDF format, so that it cannot be modified easily. The annotations made on the PDF documents are saved with particular care to ensure that the annotations are properly saved and synchronized. As illustrated, while accessing the vault offline, anything involving the “evolver” and beyond is not performed until the next the time user logs in. In the present implementation, when the file is saved, nothing happens. Only when the file is closed, the upload is triggered after a given time period, e.g., after 1-5 seconds. When uploading the annotation, the permission is set to “ownership” so that no more “new files” will be created based on the uploaded annotation. After uploading, the annotated document is linked back to the original, so that if the original file is removed, the server finds the link and removes the annotations. In the present implementation, a user may make multiple annotations on the original.

If a file is annotated in the Secure Vault, the annotated version is uploaded to the server and is stored as a new file. A link between the “original” file and “annotated” file is created and stored. The Secure Vault and My Vault display both the original and annotated versions to the user. If the original file on the server is deleted but one of the users has annotated the file in the user's Secure Vault, the file is deleted from the Secure Vault after the file has been uploaded to the server. The updated file is kept at the server side but is made inaccessible to both the deletor and annotator until the two parties have agreed on the resolution and informed the administrator of the server. If a user saves annotations to a file, the Secure Vault automatically synchronizes a corresponding file on the server to the annotated file. The annotation is recorded as a link to the original.

In the present embodiment, the annotation process involves selecting a hyperlink for a file using a browser (step 1002). The Secure Vault manager retrieves the file from the server via the evolve agent (step 1004). The file is located at the server and analyzed for the user permission (step 1006). The file is sent or downloaded to the Secure Vault (step 1008). The file is analyzed to determine whether or not it is a PDF file (step 1010). In the present implementation, the annotations are allowed to be made only on the PDF file. In other implementations, other types of files may be used for annotations. The file is opened and the user or director reviews the document and makes annotations on the document (step 1012). When the document is closed, the Secure Vault manager determines whether or not any annotation has been made on the document (step 1014). If an annotation has been made, the document with the annotation are uploaded to the server by the evolve agent (step 1016). The annotated document is saved as a new file in the My Vault of the user (step 1018), so that the original file would not be deleted. The new file is linked to the original file for easy retrieval and a mark is inserted to the file to indicate that the user who had made the annotation is the owner (step 1020). In the present implementation, only the owner of the annotated document has access to the annotated document. Another user may access the annotated document only if the owner gives permission.

The present invention has been described in terms of specific embodiments to illustrate the invention fully and enable those skilled in the art to work the invention. The embodiments or implementations described above may be altered or modified without departing from the scope of the present invention. Accordingly, the scope of the invention should not be narrowed using the above embodiments and implementations. Appended claims should be used to interpret the scope of the invention.

What is claimed is:

1. A computer-implemented method for securely handling a document in a client-server environment, the method comprising:
receiving at a server a request to initiate a session to access documents stored in a global vault associated with the server from a client; and
authenticating the request from the client; and
transferring at least one offline vault key and at least one online vault key to the client to grant access to the documents for viewing or modifying at the client.

2. The method of claim 1, wherein the documents are opened in a secure vault environment in the client, the secure vault mirroring a my-vault folder associated with the global vault.

3. The method of claim 1, further comprising:
determining whether or not any document stored at the client has been modified; and
synchronizing any document that has been determined to have been revised with a master copy of the revised document that is stored in the global vault at the server.

4. The method of claim 3, wherein the synchronization occurs during a session initiation step.

5. The method of claim 1, wherein the documents are opened in a secure vault environment in the client, the secure vault mirroring a my-vault folder associated with the global vault, wherein the documents includes first documents that are encrypted using one or more online keys and second documents that are encrypted using one or more offline keys, wherein the first documents are allowed to be accessed only while the client is log onto the server, and the second documents are allowed to be accessed both while the client is log onto the server and while the client is offline.

6. A computer-implemented method for securely handling a document in a client-server environment, the method comprising:
receiving at a server a request from a user to initiate a session to access a plurality of documents stored in a server, the documents include a first type that is allowed to be accessed only while the user is online and a second type that is allowed to be accessed while the user is both online and offline; and
transferring at least one offline vault key and at least one online vault key to a client to enable the client to load the documents and allow the user to access the documents, the documents including at least one document of first type and at least one document of second type.

7. The method of claim 6, wherein the document of first type is encrypted with an online key, and the document of second type is encrypted with an offline key, and the online key is saved in a first file, and the offline key is saved in a second file.

8. The method of claim 7, wherein the first file is encrypted using the online vault key, and the second file is encrypted using the offline vault key.

9. The method of claim 8, wherein the offline vault key is generated using a password or phrase provided by the user.

10. The method of claim 8, wherein the online vault key is generated by the server independent of the user input.

11. The method of claim 6, further comprising:
authenticating the request from the user; and
generating a download list and an upload once the user request has been authenticated to synchronize the client and server, the download list including files that need to be downloaded to the client and the upload list including files that need to be uploaded to the server.

12. The method of claim 11, wherein the user is not allowed to access the documents until the files in the download list have been downloaded and the files in the upload lists have been uploaded.

13. The method of claim 12, wherein the user reviews and makes an annotation on a given document, the method further comprising:
uploading an annotation file that includes the annotation made on the given file from the client to the server;
storing the uploaded annotation file as a new file at the server, the new file being linked to the given file.

14. The method of claim 13, wherein only the user is granted access to the new file unless the user grants access to another user.

15. The method of claim 14, wherein the new file is downloaded to a client associated with another user when the another user successfully logs onto the server if the user had indicated that the user wishes to grant the another user access to the new file.

16. The method of claim 13, wherein the upload of the annotation file is initiated upon closing of the annotation file.
